(19) United States
(12) Patent Application Publication
(10) Pub. No.: US 2019/0293602 A1
(43) Pub. Date: Sep. 26, 2019

(54) ION GENERATOR AND FINE PARTICLE SENSOR INCLUDING THE SAME

(71) Applicant: NGK Insulators, Ltd, Nagoya-Shi (JP)

(72) Inventors: Hidemasa OKUMURA, Nagoya-Shi (JP); Keiichi Kanno, Nagoya-Shi (JP); Kazuyuki Mizuno, Nagoya-Shi (JP)

(73) Assignee: NGK Insulators, Ltd, Nagoya-Shi (JP)

(21) Appl. No.: 16/352,013

(22) Filed: Mar. 13, 2019

(30) Foreign Application Priority Data
Mar. 20, 2018 (JP) 2018-053256

(51) Int. Cl. G01N 27/68

(52) U.S. Cl. CPC G01N 27/68

(57) ABSTRACT

An ion generator may be configured to generate ions within a fluid passage that is at least partly defined by an electrical insulator, where the ion generator may include: a discharge electrode placed within the fluid passage; a ground electrode placed in a vicinity of the discharge electrode; and a power source configured to intermittently apply a predetermined discharge voltage to the discharge electrode with respect to the ground electrode. The power source may be configured to apply a base voltage to the discharge electrode with respect to the ground electrode during at least part of a time period after applying the discharge voltage, the base voltage having an opposite polarity to the discharge voltage.

### CROSS-REFERENCE

This application claims priority to Japanese Patent Application No. 2018-053256, filed on Mar. 20, 2018, the entire contents of which are incorporated herein by reference.

### TECHNICAL FIELD

The art disclosed herein relates to an ion generator and a fine particle sensor including the same.

### BACKGROUND

A fine particle sensor configured to detect particles contained in fluid is known. The fine particle sensor is provided with a fluid passage to which the fluid is introduced, an ion generator configured to generate ions (meaning charged particles, the same applies hereinbelow) in the fluid passage, and a collection electrode placed downstream relative to a discharge electrode in the fluid passage. The collection electrode is configured to collect either the particles charged by the ions attaching thereto or the ions not attached to the particles. According to this fine particle sensor, an amount of the particles contained in the fluid (such as a number, a mass, and a volume of the particles) can be estimated based on an ion amount collected by the collection electrode.

An example of such a fine particle sensor is described in Japanese Patent Application Publication No. 2012-194078. This type of fine particle sensor is attached to an exhaust pipe of an automobile and is configured to detect particles contained in exhaust gas from an engine.

### SUMMARY

In a fine particle sensor, a fluid passage in which detection of particles is performed is defined by an electrical insulator such as ceramic. Due to this, when ions generated by an ion generator are in excess, an inner surface of the fluid passage is thereby charged, as a result of which a density of ions contained in fluid passing through the fluid passage may decrease. As such, the disclosure herein provides the art which suppresses an inner surface of a fluid passage from becoming charged and stably supplies ions.

The art disclosed herein may be implemented as an ion generator configured to generate ions within a fluid passage that is at least partly defined by an electrical insulator. This ion generator may comprise: a discharge electrode placed within the fluid passage; a ground electrode placed in a vicinity of the discharge electrode; and a power source configured to intermittently apply a predetermined discharge voltage to the discharge electrode with respect to the ground electrode. The power source may be configured to apply a base voltage to the discharge electrode with respect to the ground electrode during at least part of a time period after applying the discharge voltage, the base voltage having an opposite polarity to the discharge voltage.

When the predetermined discharge voltage is applied to the discharge electrode with respect to the ground electrode, ionization occurs in gaseous molecules existing in a vicinity of the discharge electrode, by which the ions are generated in the fluid passage. After this, when the base voltage having the opposite polarity to the discharge voltage is applied to the discharge electrode with respect to the ground electrode, the ions generated in the vicinity of the discharge electrode are partly attracted and absorbed by the discharge electrode. By repeating the aforementioned operation, the ion generator can ensure ion generation in the fluid passage while immediately collecting excessively-generated ions by the discharge electrode. Due to this, a suitable amount of ions is supplied in the fluid passage, and an inner surface of the fluid passage can be suppressed from becoming charged.

### BRIEF DESCRIPTION OF DRAWINGS

FIG. 1 shows a perspective view of an ion generator 10 according to an embodiment.

FIG. 2 shows an enlarged view of a fluid passage 14 of a body 12 of the ion generator 10.

FIG. 3 shows a cross-sectional view schematically showing a configuration inside the fluid passage 14 of the ion generator 10.

FIG. 4 shows a voltage waveform used in Test 1 (comparative example).

FIG. 5 shows a measurement result of Test 1 and is a graph showing a relationship between time and positive ion density.

FIG. 6 shows a voltage waveform used in Test 2 (embodiment).

FIG. 7 shows a measurement result of Test 2 and is a graph showing a relationship between base voltage Vb and positive ion density.

FIG. 8 shows voltage waveform examples 1 to 7 applied to a discharge electrode 22 with respect to ground electrodes 24.

FIG. 9 shows a measurement result of Test 3 and is a graph showing a relationship between duty ratio and positive ion density.

FIG. 10 shows a measurement result of Test 4 and is a graph showing a relationship between fluid passage dimension and positive ion density.

FIG. 11 shows a perspective view of a fine particle sensor 50 according to an embodiment.

FIG. 12 shows an enlarged view of the fluid passage 14 of the body 12 of the fine particle sensor 50.

FIG. 13 shows the body 12 of the fine particle sensor 50 attached to an exhaust pipe 6.

FIG. 14 shows a cross-sectional view schematically showing a configuration inside the fluid passage 14 of the fine particle sensor 50.

### DETAILED DESCRIPTION

According to an embodiment of the art disclosed herein, a power source may be configured to apply, to a discharge electrode with respect to a ground electrode, a voltage in a pulse wave that has an amplitude between a base voltage and a discharge voltage. According to such a configuration, the power source simply needs to control the voltage to the discharge electrode with respect to the ground electrode in a binary manner, thus a structure and operation of the power source can be implemented simply. Alternatively, a voltage in a sine wave that has an amplitude between the base voltage and the discharge voltage may be applied to the discharge electrode with respect the ground electrode. According to such a configuration, the power source of an ion generator can be simply implemented by using a general-purpose AC power source, for example.

According to an embodiment of the art disclosed herein, a magnitude of the base voltage may be within a range that does not generate ions. Since the magnitude of the base voltage may simply need to be at a degree by which generated ions can be absorbed, it can be set sufficiently small as compared to a magnitude of the discharge voltage, for example.

According to an embodiment of the art disclosed herein, the power source may be configured to be capable of regulating the magnitude of the base voltage. When the magnitude of the base voltage is regulatable, an amount of ions absorbed by the discharge electrode can thereby be adjusted, by which an amount of the ions supplied in the fluid passage can be adjusted.

According to an embodiment of the art disclosed herein, the magnitude of the discharge voltage may be within a range that is from twice to five times the magnitude of the base voltage. When such a numerical condition is satisfied, a ratio of an ion absorption amount by application of the base voltage relative to an ion generation amount by application of the discharge voltage is stabilized, by which a stabilized amount of ions can be supplied in the fluid passage.

According to an embodiment of the art disclosed herein, the fluid passage may have a rectangular cross-section. In this case, a length of a short side of the rectangular cross-section may be 9 millimeters at most. Generally, an inner surface of the fluid passage is more susceptible to becoming charged with a smaller length of the short side. In regard to this point, in the ion generator according to the art disclosed herein, the inner surface of the fluid passage can be significantly suppressed from becoming charged even when the length of the short side is 9 millimeters at most.

According to an embodiment of the art disclosed herein, a distance from the discharge electrode to a downstream end of the fluid passage may be equal to or greater than the length of the short side of the rectangular cross-section of the fluid passage. Generally, the inner surface of the fluid passage is more susceptible to becoming charged with a longer distance from the discharge electrode to the downstream end of the fluid passage. In regard to this point, in the ion generator according to the art disclosed herein, the inner surface of the fluid passage can be significantly suppressed from becoming charged even when the distance from the discharge electrode to the downstream end of the fluid passage is equal to or greater than the length of the short side of the rectangular cross-section of the fluid passage.

According to an embodiment of the art disclosed herein, the discharge voltage may be a positive voltage, and a duty ratio for intermittently applying the discharge voltage may be in a range of 5 percent to 99 percent. Alternatively, the discharge voltage may be a negative voltage, and in this case as well, a duty ratio for intermittently applying the discharge voltage may be in a range of 5 percent to 99 percent.

The ion generator disclosed herein may be employed, for example, in a fine particle sensor. In this case, the fine particle sensor may comprise: a body comprising a fluid passage that is at least partly defined by an electric insulator; the ion generator configured to generate ions within the fluid passage; and a collection electrode placed downstream relative to the discharge electrode within the fluid passage and configured to collect either fine particles charged by the ions attaching to the fine particles or the ions not attached to the fine particles. In this fine particle sensor, a suitable amount of ions is supplied in the fluid passage, thus fine particles contained in fluid can accurately be detected.

Representative, non-limiting examples of the present disclosure will now be described in further detail with reference to the attached drawings. This detailed description is merely intended to teach a person of skill in the art further details for practicing aspects of the present teachings and is not intended to limit the scope of the disclosure. Furthermore, each of the additional features and teachings disclosed below may be utilized separately or in conjunction with other features and teachings to provide improved ion generators and fine particle sensors, as well as methods for using and manufacturing the same.

Moreover, combinations of features and steps disclosed in the following detailed description may not be necessary to practice the present disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

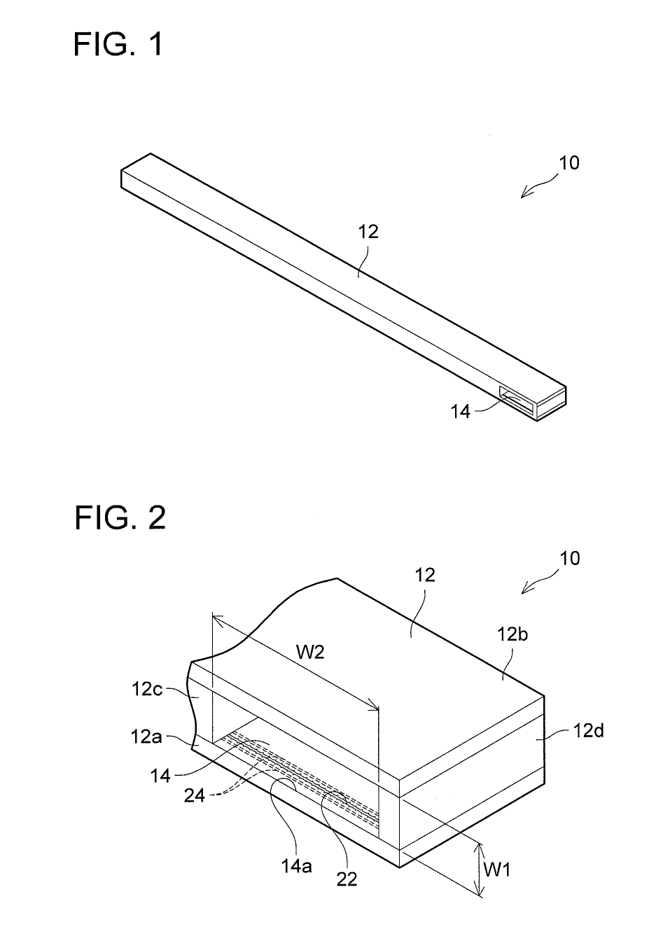

An ion generator 10 according to an embodiment will be described with reference to the drawings. As shown in FIGS. 1 to 3, the ion generator 10 according to the present embodiment is provided with a body 12 including a fluid passage 14 and is configured to supply ions 2 to fluid (which is typically gas) flowing through the fluid passage 14. Not limited to a fine particle sensor 50 to be described later, the ion generator 10 may be employed in various types of devices which require the ions 2.

The body 12 is constituted of an electrical insulator. Ceramic may be employed as the electrical insulator constituting the body 12, for example. In this case, although no particular limitation is placed, examples of the ceramic may include alumina (aluminum oxide), aluminum nitride, silicon carbide, mullite, zirconia, titania, silicon nitride, magnesia, glass, and a mixture including two or more of the aforementioned substances. Although this is merely an example, the body 12 according to the present embodiment is configured by having a first sidewall 12a, a second sidewall 12b, a body base 12c, and a bottom wall 12d joined to each other. The first sidewall 12a and the second sidewall 12b face each other, and the fluid passage 14 is defined therebetween. Further, the body base 12c and the bottom wall 12d face each other between the first sidewall 12a and the second sidewall 12b, and the fluid passage 14 is defined therebetween.

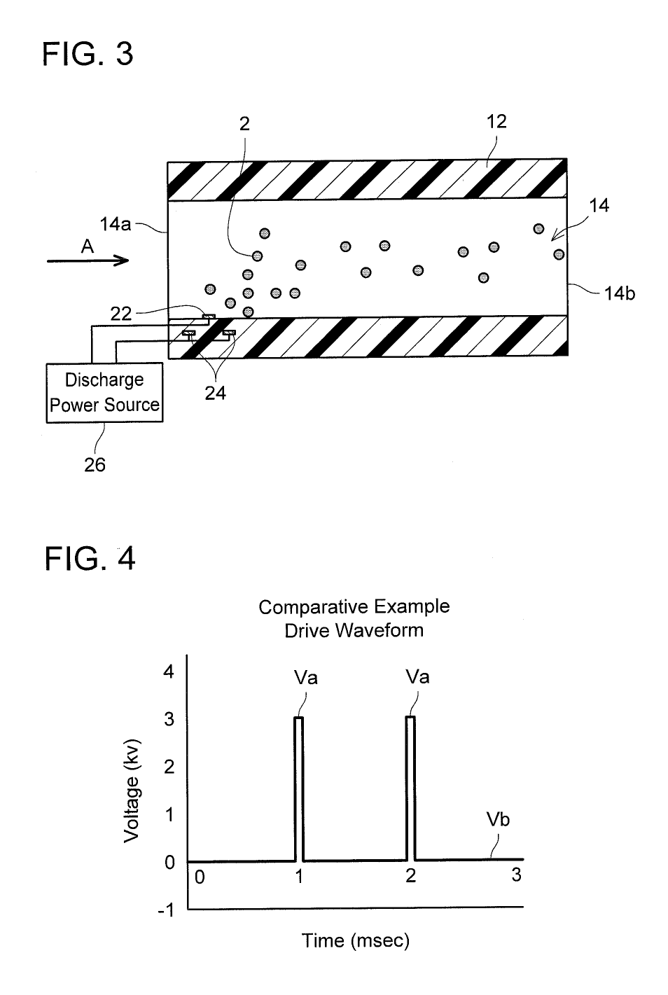

The fluid passage 14 extends through the body 12 from an opening located at its upstream end 14a to an opening located at its downstream end 14b. An arrow A in FIG. 3 indicates a flow direction of gas introduced to the fluid passage 14. The fluid passage 14 is defined by the electrical insulator constituting the body 12. That is, an inner surface of the body 12 is constituted of the electrical insulator. Although this is merely an example, the fluid passage 14 has a rectangular cross-section, a length W1 of a short side thereof is 3 millimeters and a length W2 of a long side thereof is 8 millimeters. However, a cross-sectional shape and dimensions of the fluid passage 14 are not particularly limited, and they may suitably be changed.

The ion generator 10 includes a discharge electrode 22, two ground electrodes 24, and a discharge power source 26. The discharge electrode 22 is provided on the inner surface of the fluid passage 14 in a vicinity of the upstream end 14a of the fluid passage 14. Although this is merely an example, a distance from the discharge electrode 22 to the upstream end 14a of the fluid passage 14 is 1 millimeter, and a distance from the discharge electrode 22 to the downstream end 14b of the fluid passage 14 is 9 millimeters. A position of the discharge electrode 22 in the fluid passage 14 is not particularly limited, and for example, the distance from the discharge electrode 22 to the downstream end 14b of the fluid passage 14 may be about the same as the length W1 of the short side of the rectangular cross-section of the fluid passage 14.

The two ground electrodes 24 are embedded in the body 12 in vicinities of the discharge electrode 22. Although this is merely an example, the discharge electrode 22 according to the present embodiment may extend linearly along the long side of the rectangular cross-section of the fluid passage 14, and may include a plurality of fine protrusions along a longitudinal direction thereof. Further, the two ground electrodes 24 may extend parallel to the discharge electrode 22. Materials that constitute the discharge electrode 22 and the ground electrodes 24 simply need to be conductors, and are not particularly limited. Further, the ground electrodes 24 may not be embedded in the body 12, and may be provided on the inner surface of the fluid passage 14, for example. A number of the ground electrodes 24 is not limited to two.

From a point of view regarding thermal resistance upon electric discharge, metal having a melting point of 1500° C. or higher may be employed as the material constituting the discharge electrode 22, although no particular limitation is placed thereon. Metal of this type may, for example, be titanium, chromium, iron, cobalt, nickel, niobium, molybdenum, tantalum, tungsten, iridium, palladium, platinum, gold, or an alloy including two or more of the aforementioned metals. Among such metals, when corrosion resistance is further taken into account, employing platinum or gold may be considered. The discharge electrode 22 may, for example, be bonded to the inner surface of the fluid passage 14 via glass paste. Alternatively, the discharge electrode 22 may be formed on the inner surface of the fluid passage 14 by screen-printing metal paste on the inner surface of the fluid passage 14 and baking the same to form sintered metal. The aforementioned types of metal may be employed for the material constituting the ground electrodes 24, similarly to the discharge electrode 22. The material constituting the ground electrodes 24 may be same as the material constituting the discharge electrode 22 or may be different.

Although this is merely an example, the body 12 provided with the discharge electrode 22 and the ground electrodes 24 may be manufactured by laminating a plurality of ceramic green sheets. In this case, the ceramic green sheets are firstly manufactured. Specifically, polyvinyl butyral resin (PVB) as a binder, bis(2-ethylhexyl) phthalate (DOP) as a plasticizer, and xylene and 1-butanol as solvents are added to alumina powder, and they are mixed for 30 hours in a ball mill to prepare green sheet forming slurry. This slurry is subjected to vacuum defoaming to adjust its viscosity to 4000 cps, after which a sheet material is fabricated with a doctor blade device. Shape forming and punching are performed on this sheet material so that a post-baking dimension thereof becomes the dimension of the body 12 (such as 10 millimeters), by which the green sheets are fabricated.

Then, metal paste that is to become the ground electrodes 24 (such as platinum) is screen-printed on a surface of one of the green sheets at positions where the ground electrodes 24 are to be provided on the body 12 so that a post-baking film thickness thereof becomes 5 μm, and it is dried for 10 minutes at 120° C. Further, metal paste that is to become the discharge electrode 22 is screen-printed on a surface of another one of the green sheets at a position where the discharge electrode 22 is to be provided on the body 12 so that a post-baking film thickness thereof becomes 5 μm, and it is dried for 10 minutes at 120° C. Next, those green sheets are laminated such that the ground electrodes 24 are encapsulated and the discharge electrode 22 is exposed, to form the first sidewall 12a. The bottom wall 12d, the body base 12c, and the second sidewall 12b constituted of the green sheets are laminated on the first sidewall 12a so that post-baking cross-sectional dimensions of the fluid passage 14 becomes 3 mm×8 mm, to form a laminate. This laminate is baked integrally for 2 hours at 1450° C., as a result of which the rectangular solid body 12 can be manufactured.

The discharge power source 26 is connected to the discharge electrode 22 and the ground electrodes 24, and is configured to intermittently (such as in a pulse train pattern) apply a predetermined discharge voltage to the discharge electrode 22 with respect to the ground electrodes 24. When the discharge voltage is applied to the discharge electrode 22 with respect to the ground electrodes 24, gaseous discharge occurs due to a potential difference between the discharge electrode 22 and the ground electrodes 24. At this occasion, portions of the body 12 located between the discharge electrode 22 and the ground electrodes 24 function as dielectric layers. The gaseous discharge ionizes the gas existing in the vicinity of the discharge electrode 22, by which positive or negative ions 2 are generated. Due to this, the ions 2 are supplied to the fluid flowing in the fluid passage 14.

Here, the fluid passage 14 of the body 12 is defined by the electrical insulator such as ceramic. Due to this, when the ions 2 generated by application of the discharge voltage are in excess, the inner surface of the fluid passage 14 is charged, as a result of which a density of the ions 2 contained in the fluid passing through the fluid passage 14 may be decreased. To address this, in the ion generator 10 according to the present embodiment, the discharge power source 26 is configured to apply a base voltage having an opposite polarity to the discharge voltage to the discharge electrode 22 with respect to the ground electrodes 24 during at least part of a time period after applying the discharge voltage. When the base voltage having the opposite polarity is applied to the discharge electrode 22, the ions 2 generated in the vicinity of the discharge electrode 22 are partly attracted and absorbed by the discharge electrode 22. Due to this, among the ions 2 generated by the application of the discharge voltage, the excessive ions 2 are immediately collected by the discharge electrode 22 and thus are suppressed from scattering in the fluid passage 14. Due to this, the ions 2 are supplied in an appropriate amount in the fluid passage 14, and the inner surface of the fluid passage 14 is suppressed from becoming charged. Hereinbelow, some test results are presented to explain features of the ion generator 10 according to the present embodiment.

(Test 1) In this Test 1, as a comparative example, a base voltage Vb was set to zero volts and a voltage with a waveform shown in FIG. 4 was applied to the discharge electrode 22 with respect to the ground electrodes 24. As shown in FIG. 4, a discharge voltage Va of 3 kV (kilovolts) was applied to the discharge electrode 22 in a pulse pattern at an interval of 1 millisecond. A pulse width was 100 microseconds, and a duty ratio was 10 percent. In a time period when the discharge voltage Va was not applied, zero volts was applied to the discharge electrode 22 as the base voltage Vb. A flow rate in the fluid passage 14 was adjusted to 5 litters/minute while such voltages were applied, and a positive ion density contained in the gas flowing through the fluid passage 14 was measured. For reference, an aerial ion counter manufactured by Taiei Engineering Co., Ltd. was used for the positive ion density measurement.

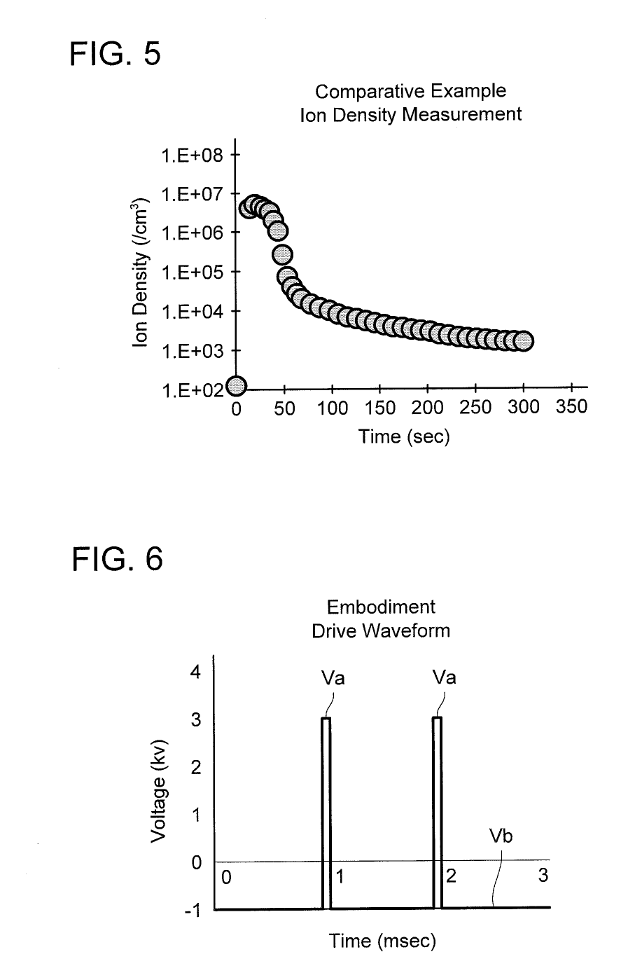

FIG. 5 shows the measurement result of Test 1. As shown in FIG. 5, the measured positive ion density was 7×10⁶ ions/cm³ immediately after start of the test, however, the positive ion density abruptly started to decrease from a time point when about 10 seconds had elapsed, and the measured positive ion density dropped to 1×10³ ions/cm³ at a time point when about 5 minutes had elapsed. As above, when the base voltage Vb is zero volts and does not have the opposite polarity to the discharge voltage Va, the positive ion density significantly decreases as time elapses. This is presumably because the inner surface of the fluid passage 14 became charged by the excessively generated positive ions, and the positive ions flowing through the fluid passage 14 decreased by a reaction force received from the charged fluid passage 14.

(Test 2) In this Test 2, as an embodiment, the base voltage Vb was changed to −1 kV and a voltage with a waveform shown in FIG. 6 was applied to the discharge electrode 22 with respect to the ground electrodes 24. As shown in FIG. 6, the discharge voltage Va of 3 kV was applied to the discharge electrode 22 in the pulse pattern at the interval of 1 millisecond. The pulse width was 100 microseconds, and the duty ratio was 10 percent. In the time period when the discharge voltage Va was not applied, the voltage of −1 kV was applied to the discharge electrode 22 as the base voltage Vb. That is, what differs from the test in the comparative example is that the base voltage Vb has the opposite polarity to the discharge voltage Va. The flow rate in the fluid passage 14 was adjusted to 5 litters/minute while such voltages were applied, and a positive ion density contained in the gas flowing through the fluid passage 14 was measured. In this test as well, the aerial ion counter manufactured by Taiei Engineering Co., Ltd. was used for the positive ion density measurement.

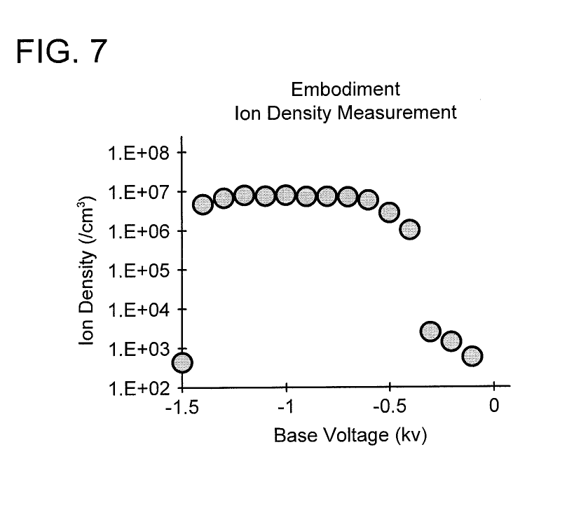

As a result of the aforementioned test, the measured positive ion density was 7×10⁶ ions/cm³ at the time point when about 5 minutes had elapsed since start of the test, and an excellent result was thereby confirmed. Then, the similar test was repeated with different base voltages Vb, and a positive ion density was measured at the time point when about 5 minutes had elapsed since start of the test for each base voltage. As a result, as shown in FIG. 7, the positive ion density increased as the base voltage Vb was reduced, and it was substantially constant at 7×10⁶ ions/cm³ in a range from −0.7 kV to −1.4 kV. The base voltage Vb was further reduced, and when it was set to −1.5 kV, the positive ion density abruptly dropped.

Next, tests to measure a negative ion density were carried out with the discharge voltage Va of −3 kV without changing the other conditions while the base voltage Vb is changed from zero volts to 1 kV, as a result of which results similar to those of the positive ion density as aforementioned were confirmed. It is understood from these results that the ions 2 are stably supplied in the fluid passage 14 by setting the base voltage Vb applied after the discharge voltage Va to have the opposite polarity to the discharge voltage Va.

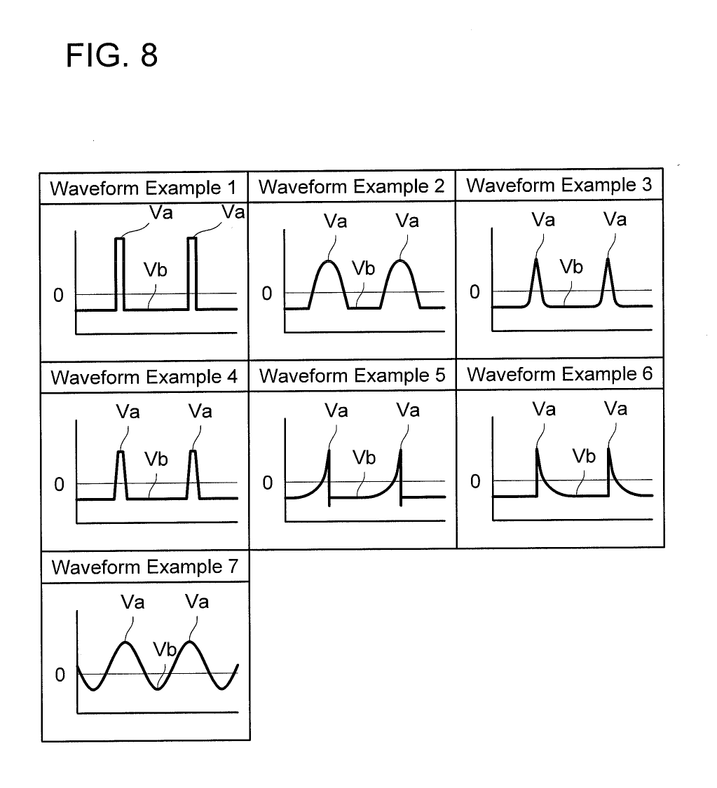

Here, the waveform of the voltage applied to the discharge electrode 22 with respect to the ground electrodes 24 may be modified variously as exemplified, for example, in FIG. 8. In waveform examples 1 to 7 shown in FIG. 8, the discharge voltage Va is a positive voltage and the base voltage Vb is a negative voltage, thus the base voltage Vb has the opposite polarity to the discharge voltage Va. From a view point of simplifying the discharge power source 26, one of a pulse wave of the waveform example 1, a half-sin wave of the waveform example 2, and a sine wave of the waveform example 7 is preferably employed. In regard to the pulse wave, the discharge power source 26 may be constituted by using a DC power source and a DC voltage may intermittently be outputted by a switching element. In regard to the half-sin wave and the sine wave, the discharge power source 26 may be constituted by using an AC power source, and power thereof may be outputted via a diode or directly. In any of the waveform examples 1 to 7 shown in FIG. 8, the polarities of the voltages may be inverted, thus the discharge voltage Va may be a negative voltage and the base voltage Vb may be a positive voltage.

When the flow rate in the fluid passage 14 was adjusted to 5 litters/minute, a wind speed measured at the opening of the fluid passage 14 was 1.77 meters per second. The flow rate in the fluid passage 14 was adjusted to gradually decrease, and when the flow rate reached 1.5 litters/minute, the measured ion density remained relatively small even when the base voltage Vb was set to have the opposite polarity to the discharge voltage Va. At this occasion, the wind speed measured at the opening of the fluid passage 14 was 0.57 meters per second. To the contrary, when the flow rate in the fluid passage 14 was adjusted to gradually increase, no decrease in the ion density was observed when the flow rate reached 15 litters/minute, and the measured ion density remained relatively high even without setting the base voltage Vb to have the opposite polarity to the discharge voltage Va. At this occasion, the wind speed measured at the opening of the fluid passage 14 was 4.5 meters per second.

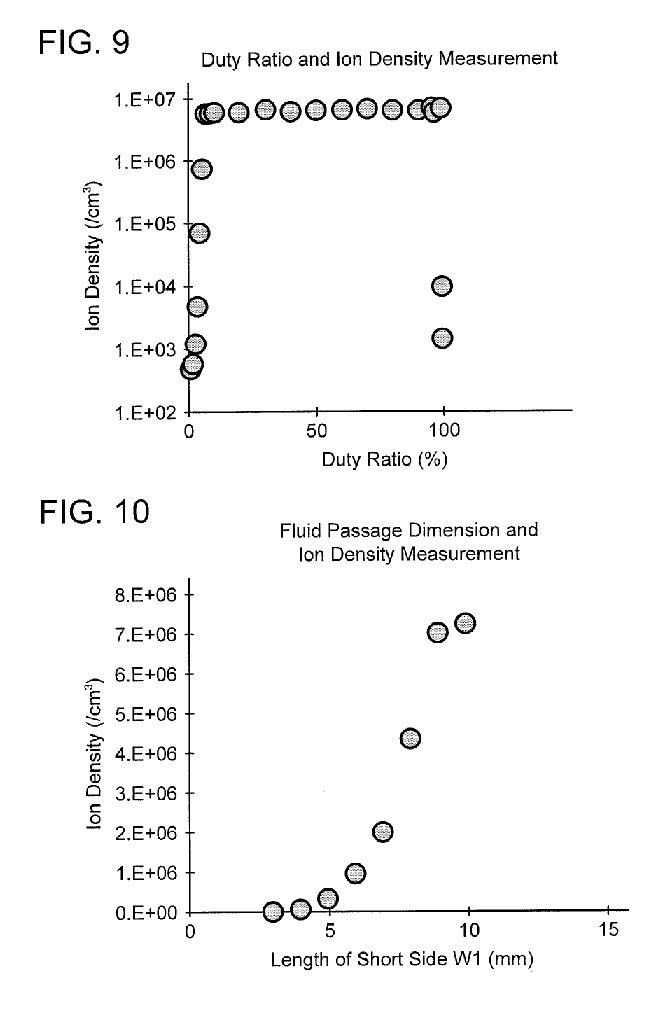

(Test 3) In this Test 3, a positive ion density was measured with different duty ratios of the discharge voltage Va applied to the discharge electrode 22 with respect to the ground electrodes 24 at the time point when 5 minutes had elapsed since start of the test. The discharge voltage Va was 3 kV, the base voltage Vb was −1 kV, and a cycle was 1 millisecond. As a result, as shown in FIG. 9, the positive ion density was substantially constant at 7×10⁶ ions/cm³ in a range where the duty ratio is from 5 percent to 99 percent, however, the positive ion density abruptly dropped when the duty ratio exceeded 99 percent.

Next, with the discharge voltage Va changed to −3 kV and the base voltage Vb changed to −1 k V, tests to measure a negative ion density at the time point when 5 minutes had elapsed since start of the tests were carried out. As a result, similarly to the positive ion measurement, the negative ion density was substantially constant at 7×10⁶ ions/cm³ in the range where the duty ratio is from 5 percent to 99 percent, however, the negative ion density abruptly dropped when the duty ratio exceeded 99 percent. According to these results, it has been confirmed that the ions 2 can stably be supplied in the fluid passage 14, in both cases of the positive ions and the negative ions, so long as the duty ratio for applying the discharge voltage Va is in the range from 5 percent to 99 percent.

(Test 4) In this Test 4, a plurality of bodies 12 having different lengths W1 for the short side of the rectangular cross-section of the fluid passage 14 was prepared, and a positive ion density was measured for each of the bodies 12 at the time point when 5 minutes had elapsed since start of the test. In order to confirm an influence of the length W1 of the short side of the fluid passage 14, the base voltage Vb was set to zero volts and the voltage with the waveform shown in FIG. 4 was applied to the discharge electrode 22 with respect to the ground electrodes 24. As a result, as shown in FIG. 10, the positive ion density was very small when the length W1 of the short side was 5 millimeters or less, and the positive ion density abruptly increased when the length W1 of the short side exceeded 5 millimeters. Further, when the length W1 of the short side was 9 millimeters or greater, the positive ion density reached 7×10⁶ ions/cm³. From these results, it has been confirmed that the positive ion density drops when the length W1 of the short side is 9 millimeters at most in the case where the base voltage Vb is zero volts. Contrary to this, in Test 2 as aforementioned, the measured positive ion density was 7×10⁶ ions/cm³ despite the length W1 of the short side being 3 millimeters, by setting the base voltage Vb to have the opposite polarity to the discharge voltage Va. According to the above, it has been confirmed that the density drop in the ions 2 is significantly suppressed by setting the base voltage Vb to have the opposite polarity to the discharge voltage Va in the case where the length W1 of the short side is 9 millimeters at most.

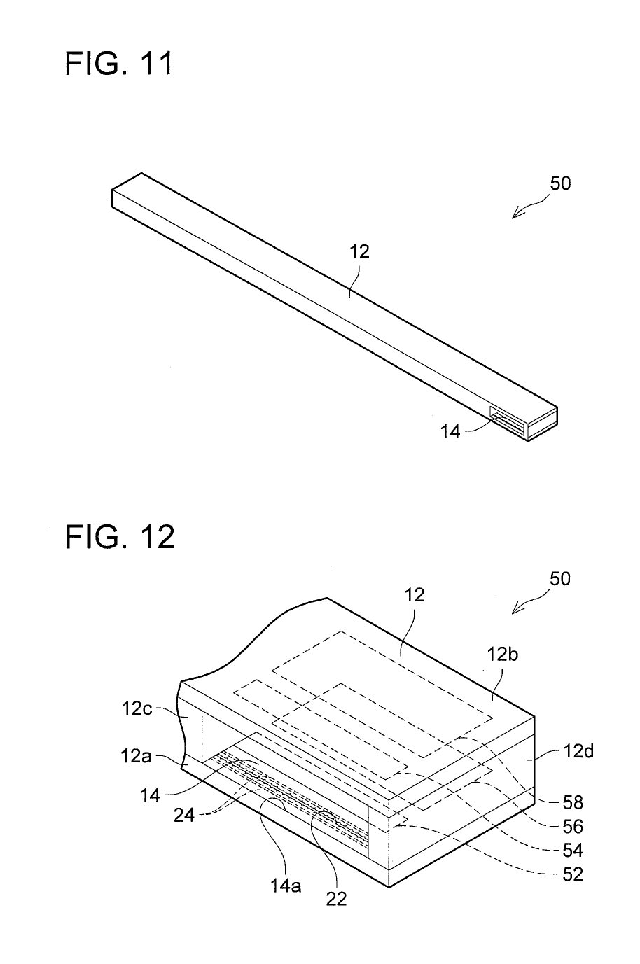

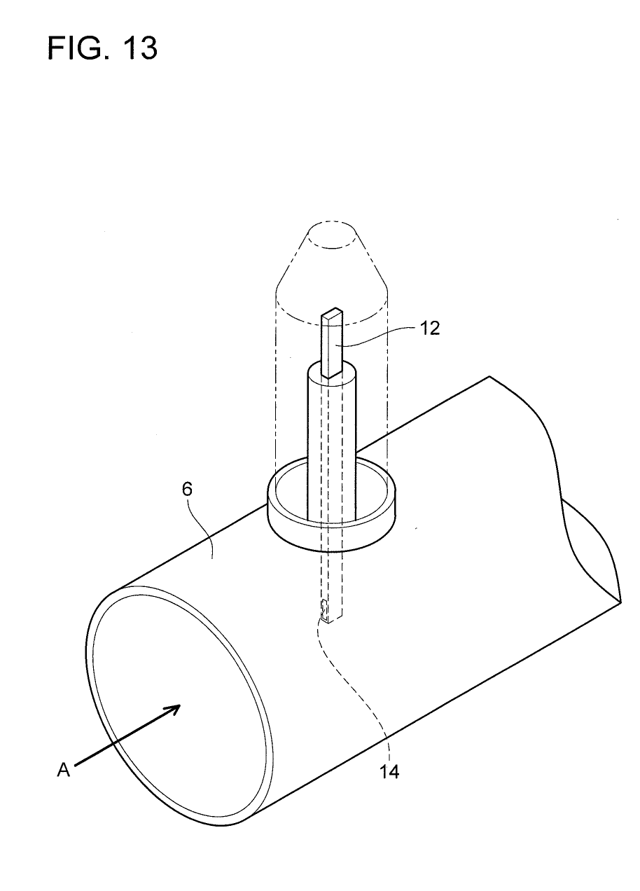

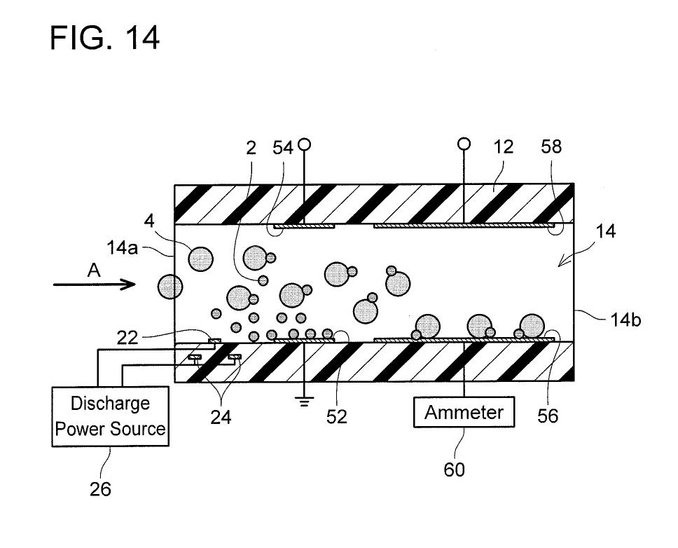

Next, the fine particle sensor 50 according to an embodiment will be described with reference to FIGS. 11 to 14. The fine particle sensor 50 according to the present embodiment is constituted by using the aforementioned ion generator 10. Portions corresponding to the ion generator 10 are given the same reference signs and redundant explanation thereof will be omitted.

The fine particle sensor 50 according to the present embodiment is mounted, for example, in an automobile and is used to monitor a number of fine particles contained in exhaust gas from an engine. The fine particle sensor 50 includes the body 12 including the fluid passage 14. The body 12 is attached within the exhaust pipe 6 connected to the engine, and the fluid passage 14 of the body 12 is placed within the exhaust pipe 6. The fine particle sensor 50 is configured to measure a number of fine particles 4 contained in the exhaust gas flowing through the fluid passage 14.

The body 12 includes the discharge electrode 22, the ground electrodes 24, a first collection electrode 52, a first electric field generating electrode 54, a second collection electrode 56, and a second electric field generating electrode 58. As aforementioned, the discharge electrode 22 is provided on the inner surface of the fluid passage 14 and the ground electrodes 24 are embedded in the body 12 in the vicinities of the discharge electrode 22. The discharge electrode 22 and the ground electrodes 24 are connected to the discharge power source 26, and the discharge voltage Va is intermittently applied. Due to this, the ions 2 are generated in the fluid passage 14, and the fine particles 4 are charged by those ions 2 attaching to the fine particles 4 in the exhaust gas. At this occasion, a number of the ions 2 that attach to each of the fine particles 4 is substantially constant (such as one).

The discharge power source 26 is configured to apply the base voltage Vb having the opposite polarity to the discharge voltage Va to the discharge electrode 22 with respect to the ground electrodes 24 during at least part of the time period after applying the discharge voltage Va (for example, see FIGS. 6 and 8). Due to this, as aforementioned, the suitable amount of the ions 2 is supplied in the fluid passage 14 and the density of the ions 2 supplied to the exhaust gas stabilizes over time. As such, the fine particle sensor 50 can detect the fine particles 4 contained in the exhaust gas with high accuracy.

The first collection electrode 52 and the first electric field generating electrode 54 are provided on the inner surface of the fluid passage 14 and placed downstream relative to the discharge electrode 22. The first collection electrode 52 and the first electric field generating electrode 54 face each other. The first collection electrode 52 and the first electric field generating electrode 54 are connected to a DC power source (not shown) and generate an electric field therebetween. This electric field is relatively weak, thus only the excessive ions 2 that are not attached to the fine particles 4 are attracted toward the first collection electrode 52 and are collected by the first collection electrode 52. The charged fine particles 4 (that is, the fine particles 4 to which the ions 2 are attached) have a larger mass than the ions 2, thus they flow through between the first collection electrode 52 and the first electric field generating electrode 54 without being collected by the first collection electrode 52.

The second collection electrode 56 and the second electric field generating electrode 58 are provided on the inner surface of the fluid passage 14 and placed downstream relative to the first collection electrode 52 and the first electric field generating electrode 54. The second collection electrode 56 and the second electric field generating electrode 58 face each other. The second collection electrode 56 and the second electric field generating electrode 58 are connected to a DC power source (not shown) and generate an electric field therebetween. This electric field generated between the second collection electrode 56 and the second electric field generating electrode 58 is stronger than the electric field generated between the first collection electrode 52 and the first electric field generating electrode 54. As such, the charged fine particles 4 are attracted toward the second collection electrode 56 and are collected by the second collection electrode 56. An ammeter 60 is connected to the second collection electrode 56, for example. A measured value of the ammeter 60 corresponds to a number of the fine particles 4 collected per unit time by the second collection electrode 56. As such, the number of the fine particles 4 contained in the exhaust gas or a density thereof can be measured based on the measured value of the ammeter 60 and other indexes (such as a flow rate of the exhaust gas flowing through the fluid passage 14).

When a DC voltage applied between the second collection electrode 56 and the second electric field generating electrode 58 is decreased, the fine particles 4 having the large mass are not collected by the second collection electrode 56 and thus flow through between the second collection electrode 56 and the second electric field generating electrode 58. Contrary to this, when the DC voltage applied between the second collection electrode 56 and the second electric field generating electrode 58 is increased, the fine particles 4 with the large mass can be attracted to the second collection electrode 56 and collected thereby. Due to this, by regulating the DC voltage applied between the second collection electrode 56 and the second electric field generating electrode 58, the fine particles 4 having the mass in a specific range can selectively be collected and a number or a density thereof can be measured. Thus, by changing the DC voltage applied between the second collection electrode 56 and the second electric field generating electrode 58 in stages for example, the fine particles 4 contained in the exhaust gas can be classified, and a number or a density thereof can be measured.

Here, there is a negative correlation between the number of the excessive ions 2 collected by the first collection electrode 52 and the number of the charged fine particles 4 collected by the second collection electrode 56. That is, the greater the number of the fine particles 4 contained in the exhaust gas is, the less the number of the excessive ions 2 collected by the first collection electrode 52 is, whereas the greater the number of the charged fine particles 4 collected by the second collection electrode 56 is. Due to this, as another embodiment, the ammeter 60 may be connected to the first collection electrode 52 to measure the number of the excessive ions 2, and the number of the fine particles 4 may be estimated based on the measured value thereof. With such a configuration, the second collection electrode 56 and the second electric field generating electrode 58 are not necessarily needed, and thus they may be omitted.

What is claimed is:

1. An ion generator configured to generate ions within a fluid passage that is at least partly defined by an electrical insulator, the ion generator comprising:
a discharge electrode placed within the fluid passage;
a ground electrode placed in a vicinity of the discharge electrode; and
a power source configured to intermittently apply a predetermined discharge voltage to the discharge electrode with respect to the ground electrode,
wherein
the power source is configured to apply a base voltage to the discharge electrode with respect to the ground electrode during at least part of a time period after applying the discharge voltage, the base voltage having an opposite polarity to the discharge voltage.

2. The ion generator according to claim 1, wherein the power source is configured to apply, as the discharge voltage, a voltage in a pulse wave or in a sine wave to the discharge electrode with respect to the ground electrode, the voltage in the pulse wave or in the sine wave having an amplitude between the base voltage and the discharge voltage.

3. The ion generator according to claim 1, wherein a magnitude of the base voltage is within a range that does not generate ions.

4. The ion generator according to claim 1, wherein the power source is configured to be capable of regulating a magnitude of the base voltage.

5. The ion generator according to claim 1, wherein a magnitude of the discharge voltage is within a range that is from twice to five times a magnitude of the base voltage.

6. The ion generator according to claim 1, wherein
the fluid passage has a rectangular cross-section, and
a length of a short side of the rectangular cross-section is 9 millimeters at most.

7. The ion generator according to claim 6, wherein a distance from the discharge electrode to a downstream end of the fluid passage is equal to or greater than the length of the short side of the rectangular cross-section of the fluid passage.

8. The ion generator according to claim 1, wherein
the discharge voltage is a positive voltage, and
a duty ratio for intermittently applying the discharge voltage is in a range of 5 percent to 99 percent.

9. The ion generator according to claim 1, wherein
the discharge voltage is a negative voltage, and
a duty ratio for intermittently applying the discharge voltage is in a range of 5 percent to 99 percent.

10. A fine particle sensor, comprising:
a body comprising a fluid passage that is at least partly defined by an electric insulator;
the ion generator according to claim 1 that is configured to generate ions within the fluid passage; and
a collection electrode placed downstream relative to the discharge electrode within the fluid passage and configured to collect either particles charged by the ions attaching to the particles or the ions not attached to the particles.
